(19) United States
(12) Patent Application Publication
(10) Pub. No.: US 2008/0296079 A1
(43) Pub. Date: Dec. 4, 2008

(54) Safety system for alerting speed of vehicle

(76) Inventor: Hou-Wang Kao, Taipei Hsien (TW)

Correspondence Address: HOU-WANG KAO, 235 Chung-Ho, Box 8-27, Taipei, TW

(21) Appl. No.: 11/809,260

(22) Filed: Jun. 1, 2007

(51) Int. Cl. B60R 21/01

(52) U.S. Cl. 180/282

(57) ABSTRACT

A safety system for alerting a speed of a vehicle, comprises the rotary unit; the elastic element having one end engaged to the rotary unit; a side of the base having a via hole; the base having a groove; the rotary unit being placed upon the groove of the base; the control circuit board seat connected to a brake bulb and a power plug; a switch of the control circuit board seat being inserted into the base and the rotary unit; a plurality of studs serving to lock the control circuit board seat to the base; the rotary unit being wound with a connecting wire which passes through the via hole; the outer cover being fixed upon an upper side of the groove of the base by using screws so as to seal the groove.

### FIELD OF THE INVENTION

The present invention relates to urgent alerts of cars, and particularly to a safety system for alerting a speed of a vehicle, wherein signals about the tightness of a throttle pedal are transferred to a signal control box to be converted so that the braking light flashes with different extents according to the braking state of the car and thus the driver at the rear side of the car can generate a desire reaction.

### BACKGROUND OF THE INVENTION

Referring to FIG. 7, a general car has a braking light C. In driving in high way, if a car D at a front side has some conditions, the driver of the front side treads upon the braking pedal A so that the car D will brake urgently to make the brake light C lights up. Then the driver of a car E at the back side will see the brake light to light up so as to retain a safety distance. However, at the time that the driver of the car D leaves the throttle pedal to the braking pedal, the driver of the car E can not detect the condition occurring in the front car D. Thus at this moment, the two cars are not at a safety distance. As a result, the braking distance is not sufficient for a safety reaction, especially in high speed driving and thus the possibility for occurring accidents will increase greatly.

### SUMMARY OF THE INVENTION

Accordingly, the primary object of the present invention is to provide a safety system for alerting a speed of a vehicle, wherein signals about the tightness of a throttle pedal are transferred to a signal control box to be converted so that the braking light flashes with different extents according to the braking state of the car and thus the driver at the rear side of the car can generate a desire reaction.

To achieve above objects, the present invention provides a safety system of alerting a speed of a vehicle, comprises the rotary unit; the elastic element having one end engaged to the rotary unit; a side of the base having a via hole; the base having a groove; the rotary unit being placed upon the groove of the base; the control circuit board seat connected to a brake bulb and a power plug; a switch of the control circuit board seat being inserted into the base and the rotary unit; a plurality of studs serving to lock the control circuit board seat to the base; the rotary unit being wound with connecting wire which passes through the via hole; the outer cover being fixed upon an upper side of the groove of the base by using screws so as to seal the groove; wherein the connecting wire winds around the rotary unit and is connected to the actuated switch and then is connected to a throttle pedal or an acceleration rope in the engine chamber; the control circuit board seat is connected to a power source; when the connecting wire is pulled and then returned, the rotary unit will control the actuation switch.

The various objects and advantages of the present invention will be more readily understood from the following detailed description when read in conjunction with the appended drawing.

### BRIEF DESCRIPTION OF THE DRAWINGS

FIG. 1 is an assembled view of the present invention.

FIG. 2 is an exploded perspective view of the present invention.

FIG. 3 is a schematic view showing the embodiment of the present invention.

FIG. 4 is a schematic cross sectional view of the embodiment of the present invention.

FIG. 5 is a schematic view showing the operation of the present invention.

FIG. 6 is a schematic view showing another application of the present invention.

FIG. 7 shows the prior art of the present invention.

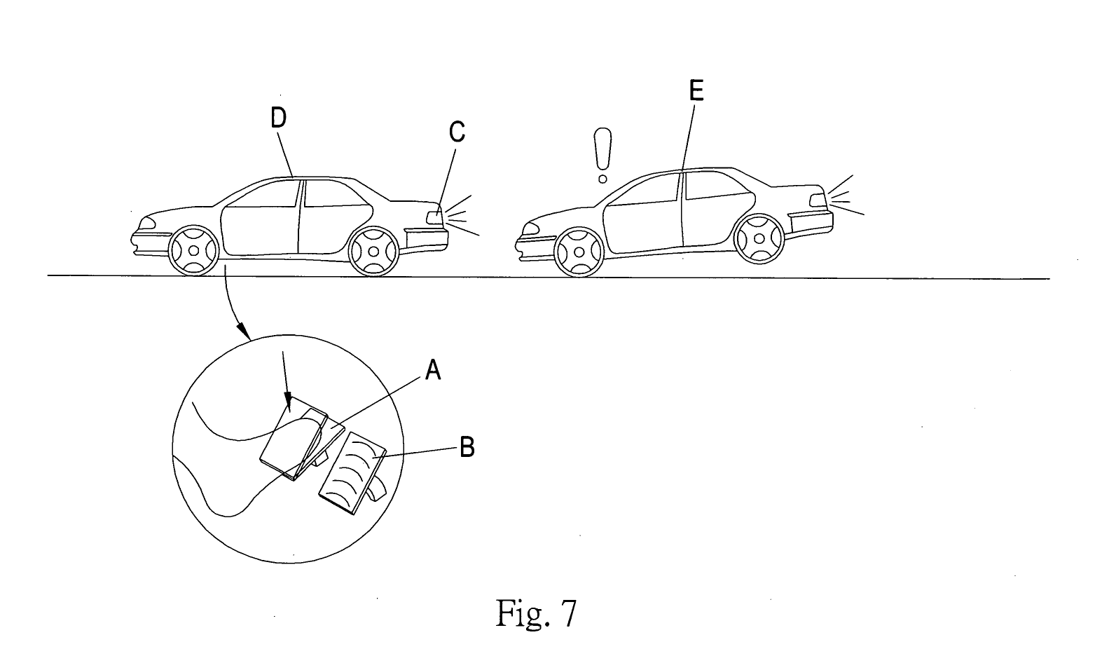

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

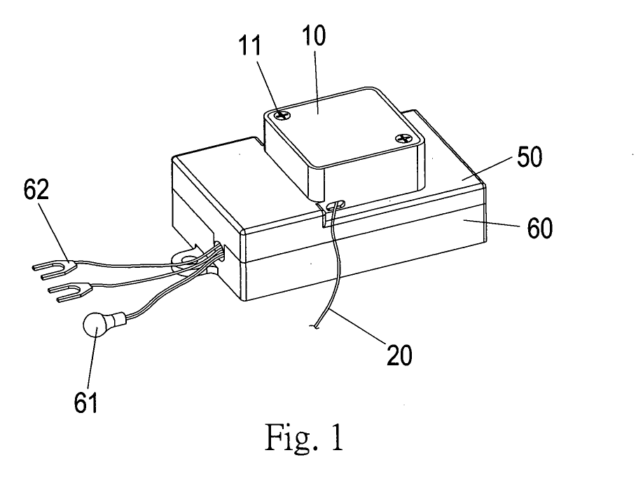

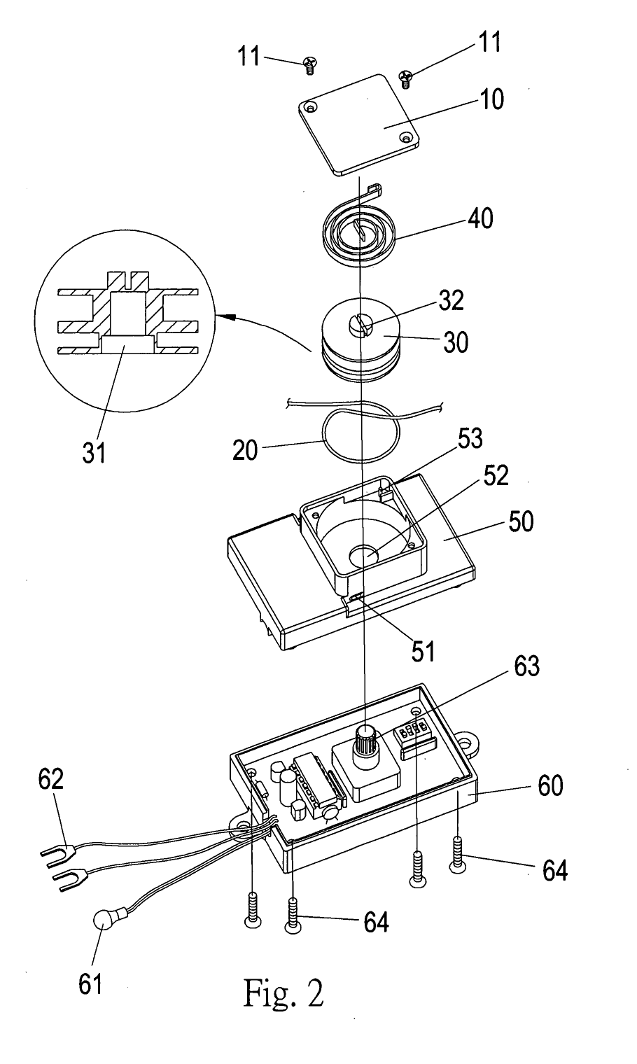

Referring to FIGS. 1 and 2, the structure of the present invention includes an outer cover 10, a connecting wire 20, a rotary unit 30, an elastic element 40, a base 50, and a control circuit board seat 60.

The rotary unit 30 is formed with a recess 31. The rotary unit 30 has a post 32. A center of the post 32 has a trench.

The elastic element 40 has one end engaged to the trench of the post 32 of the rotary unit 30.

A side of the base 50 has a via hole 51. The base 50 has a groove. The base 50 is formed with a through hole 50 corresponding to the recess 31 of the rotary unit 30. The rotary unit 30 is placed upon the groove of the base 50. The groove of the base 50 is formed with a bar 53 for connecting another end of the elastic element 40.

The control circuit board seat 60 is connected to a brake bulb 61 and a power plug 62. A switch 63 of the control circuit board seat 60 is inserted into the base 50 and the rotary unit 30. A plurality of studs serve to lock the control circuit board seat 60 to the base 50. The rotary unit 30 is wound with connecting wire 20 which passes through the via hole 51.

The outer cover 10 is fixed upon an upper side of the groove of the base 50 by using screws 11 so as to seal the groove.

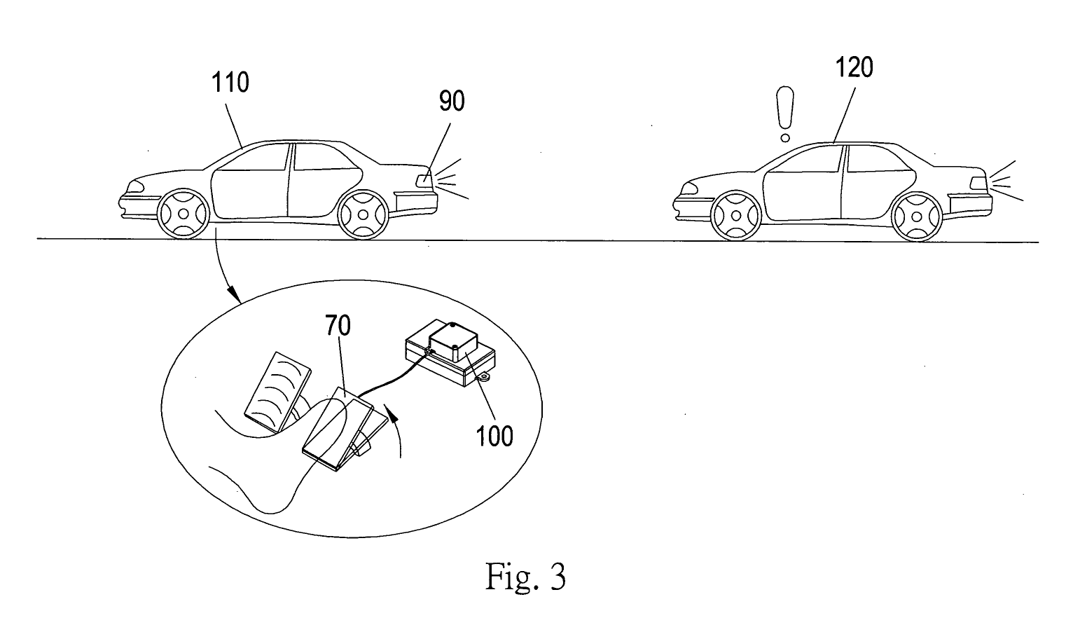

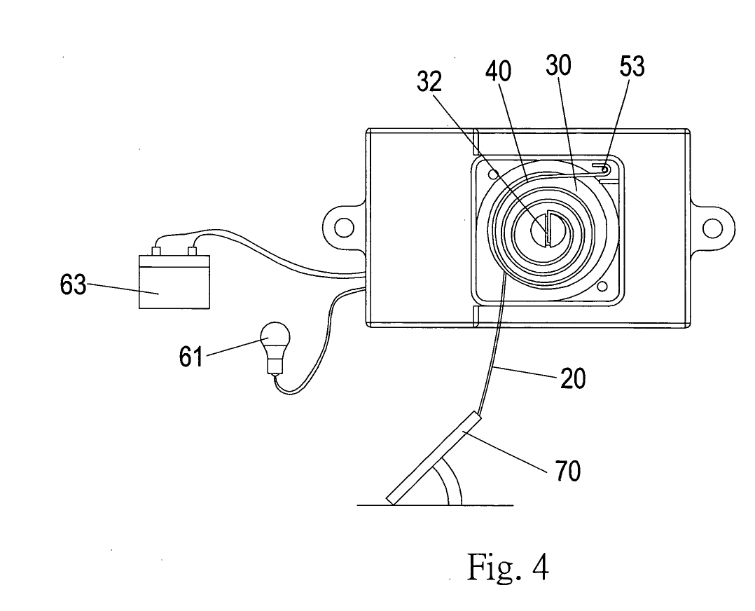

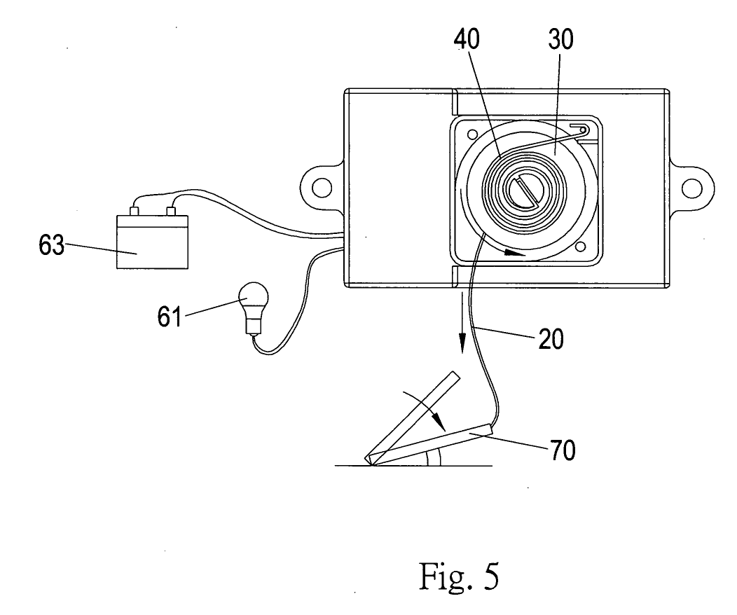

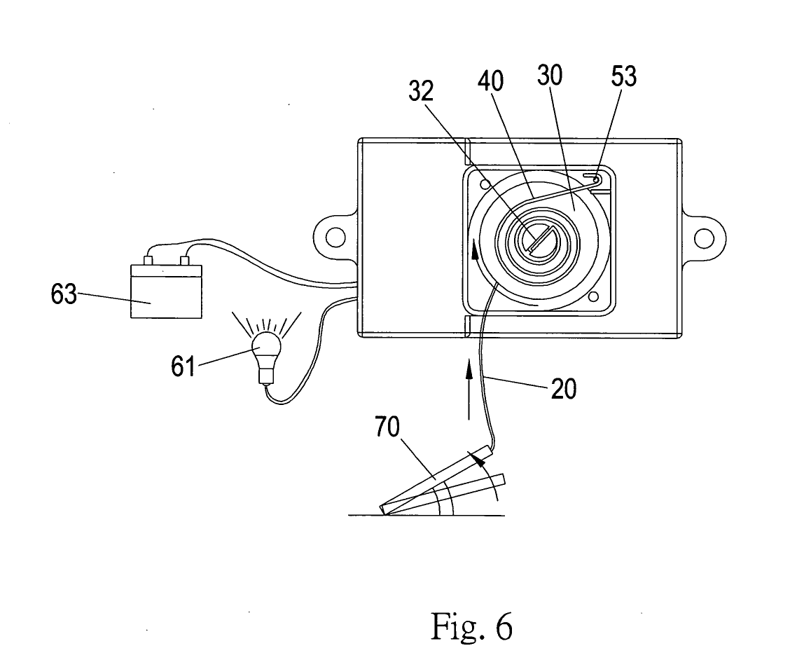

Referring to FIGS. 2 to 6, the connecting wire 20 winds around the rotary unit 30 and is connected to the actuated switch 63 and then is connected to a throttle pedal 70 or an acceleration rope in the engine chamber (not shown). The control circuit board seat 60 is connected to a power source 65. When the connecting wire 20 is pulled and then returned, the rotary unit 30 will control the actuation switch, and the elastic element 40 will generate a resilient force due to rotation so that the connecting wire 20 will return automatically to drive the switch 63 of the control circuit board seat 60 (referring to FIG. 2) to generate control signals. When the throttle pedal 70 is treaded to pull the rotary unit 30, the elastic element 40 will reduce and tighten (referring to FIG. 5). Then by the releasing of the throttle pedal 70, the elastic element 40 will release to drive the rotary unit 30 to rotate the switch 63 of the control circuit board seat 60 (referring to FIG. 2). As a result, the control circuit board seat 60 controls the brake bulb 61 to flash (referring to FIG. 6). A driver at a front car 110 will release the throttle pedal 70 to make a control box 100 to cause the rear light 90 to flash. Thus the driver of the rear car 120 has a longer reaction time for braking.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A safety system for alerting a speed of a vehicle, comprising:
a rotary unit;
an elastic element having one end engaged to the rotary unit;
a base, a side of the base having a via hole; the base having a groove; the rotary unit being placed upon the groove of the base;
a control circuit board seat connected to a brake bulb and a power plug; a switch of the control circuit board seat being inserted into the base and the rotary unit; a plurality of studs serving to lock the control circuit board seat to the base; the rotary unit being wound with a connecting wire which passes through the via hole;
an outer cover being fixed upon an upper side of the groove of the base by using screws so as to seal the groove;
wherein the connecting wire winds around the rotary unit and is connected to the actuated switch and then is connected to a throttle pedal or an acceleration rope in the engine chamber; the control circuit board seat is connected to a power source; when the connecting wire is pulled and then returned, the rotary unit will control the actuation switch, and the elastic element will generate a resilient force due to rotation so that the connecting wire will return automatically to drive the switch of the control circuit board seat to generate control signals; the control circuit board seat controls the brake bulb to flash; a driver at a front car will release the throttle pedal to make a control box to cause the rear light to flash; thus the driver of the rear car has a longer reaction time for braking.

2. The safety system for alerting a speed of a vehicle as claimed in claim 1, wherein the elastic element is one of a spring and a gear set.

3. The safety system for alerting a speed of a vehicle as claimed in claim 1, wherein the control circuit board seat is connected to an alarm light for a vehicle.

4. The safety system for alerting a speed of a vehicle as claimed in claim 1, wherein the rotary unit has a post; the elastic element has one end engaged to the trench of the post of the rotary unit; in the groove of the base has a bar for connecting another end of the elastic element.

5. The safety system for alerting a speed of a vehicle as claimed in claim 1, wherein the rotary unit is formed with a recess; the base is formed with a through hole corresponding to the recess of the rotary unit for combining the control circuit board seat to the rotary unit and the base.
